(19) United States
(12) Patent Application Publication
(10) Pub. No.: US 2003/0235379 A1
(43) Pub. Date: Dec. 25, 2003

(54) Electro-optical cable, plug and socket

(76) Inventor: Hsi-Chung Lin, Shindian City (TW)

Correspondence Address: BIRCH STEWART KOLASCH & BIRCH, PO BOX 747, FALLS CHURCH, VA, 22040-0747, US

(21) Appl. No.: 10/173,843

(22) Filed: Jun. 19, 2002

(51) Int. Cl. G02B 6/44; G02B 6/36; G02B 6/38

(52) U.S. Cl. 385/101; 385/75; 385/53

(57) ABSTRACT

An electro-optical cable, plug and socket comprising an electro-optical cable, an electro-optical plug and an electro-optical socket, the electro-optical cable wraps a plastic fiber optics and two copper wires together; the electro-optical plug in a shell body with a fiber optics plug and a line power plug; the fiber optics plug connects to the plastic fiber optics, the line power plug connects to the copper wires; the electro-optical socket is a base with a fiber optics socket and a line power socket; the electro-optical socket is installed on an electro-optical peripheral circuit board. The mechanism can reduce the numbers of different cables, plugs and sockets that reduces the tedious wiring and troublesome.

### BACKGROUND OF THE INVENTION

I. Field of the Invention

This invention relates generally to an electro-optical cable, plug and socket and, more specifically, to an electro-optical cable, plug and socket comprises an electro-optical cable, an electro-optical plug and an electro-optical socket. The electro-optical cable wraps a plastic fiber optics and two copper wires together. The electro-optical plug in a shell body with a fiber optics plug and a line power plug; the fiber optics plug connects to the plastic fiber optics, the line power plug connects to the copper wires. The electro-optical socket is a base with a fiber optics socket and a line power socket; the electro-optical socket is installed on an electro-optical peripheral circuit board. The mechanism can reduce the numbers of different cables, plugs and sockets that reduces the tedious and troublesome.

II. Description of the Prior Art

Heretofore, it is known that a general automobile equips besides a traditional radio, it might have a CD stereo, even DVD video equipment. A DVD needs an LCD display. The automobile might even have the advanced GPS system. All these equipments are connected with copper wires, however copper wires can be interfered by other signals that degrades the transmission quality.

It is also known that the stereo, broadcast and communication systems in home and office also apply copper wires to transmit signals, these copper wires can also be interfered by other signals that degrades the transmission quality, the longer the distance the worse the signal attenuation condition.

In order to improve the transmission quality and signal attenuation condition, the better way is to connect all the components with fiber optics. The fiber optics system needs other equipments, such as optical signal distributor, optical signal amplifier electro-optical equipments, as shown in FIG. 13, the main control unit (a) connects to an analog signal to optical signal converter (b); the main control unit (a) further connects to an optical signal distributor (c), the optical signal distributor (c) further connects to other electro-optical appliances; or the main control unit (a) can connect to an optical signal amplifier (d), the optical signal amplifier (d) connects to another optical signal distributor (c′); or the main control unit (a) can connect to an optical signal to analog or digital signal converter (e), the converter (e) then connects to other appliances (f).

All these peripheral equipments (optical signal distributor c, optical signal amplifier d and converter b, e) and the appliances f not only receive signals but also need to connect to the power sources, therefore when all the peripheral equipments and the appliances connect together causes many cables around that introduces tedious and inconvenience.

All the peripheral equipments and the appliances need power circuitry, transformer, for example, therefore these power circuitries not only increase the physical size and weigh but also the cost.

### SUMMARY OF THE INVENTION

It is therefore a primary object of the invention to provide an electro-optical cable, plug and socket that wraps a plastic fiber optics and twp copper wires together with a fiber optics plug and a line power plug on both ends, and have the electro-optical socket with both fiber optics socket and line power socket on the appliances, such scheme can reduce the numbers of different cables, plugs and sockets that reduces the tedious wiring and troublesome.

In order to achieve the objective set forth, an electro-optical cable, plug and socket in accordance with the present invention comprises an electro-optical cable, an electro-optical plug and an electro-optical socket. The electro-optical cable wraps a plastic fiber optics and two copper wires together. The electro-optical plug in a shell body with a fiber optics plug and a line power plug; the fiber optics plug connects to the plastic fiber optics, the line power plug connects to the copper wires. The electro-optical socket is a base with a fiber optics socket and a line power socket; the electro-optical socket is installed on an electro-optical peripheral circuit board.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the electro-optical cable of the present invention;

FIG. 2 is a cross-sectional view of the electro-optical cable of the present invention;

FIG. 3 is a perspective view of the electro-optical plug of the present invention;

FIG. 4 is a perspective view of the electro-optical socket of the present invention;

FIG. 5 is an assembly view the present invention;

FIG. 6 is another cross-sectional view of the electro-optical cable of the present invention;

FIG. 7 is another assembly view of the electro-optical cable of the present invention;

FIG. 8 shows the electro-optical plug of the present invention with a fiber optics plug and line power plug;

FIG. 9 is another embodiment of the electro-optical plug of the present invention;

FIG. 10 is partially sectional view of the FIG. 9.

FIG. 11 is a further embodiment of the electro-optical plug of the present invention;

FIG. 12 is a further embodiment of the electro-optical plug of the present invention;

FIG. 13 is a schematic drawing of a prior art.

### DESCRIPTION OF THE PREFERRED EMBODIMENT

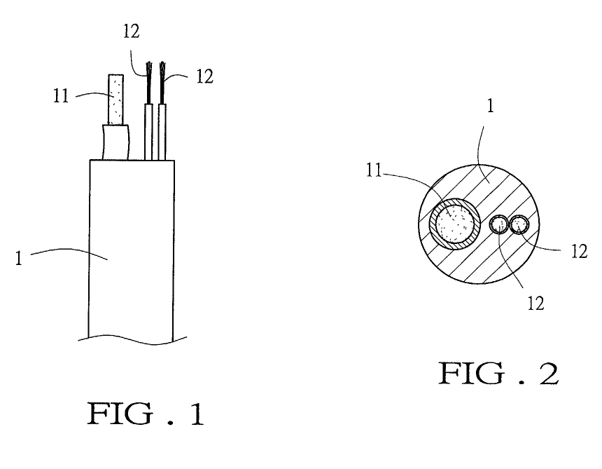

Referring to FIG. 1 to FIG. 4, the present invention is composed of an electro-optical cable 1, an electro-optical plug 2 and an electro-optical socket 3. The functions of each component are described below:

The electro-optical cable 1 wraps a plastic fiber optics 11 and two copper wires 12 together, as shown in FIG. 1 and FIG. 2.

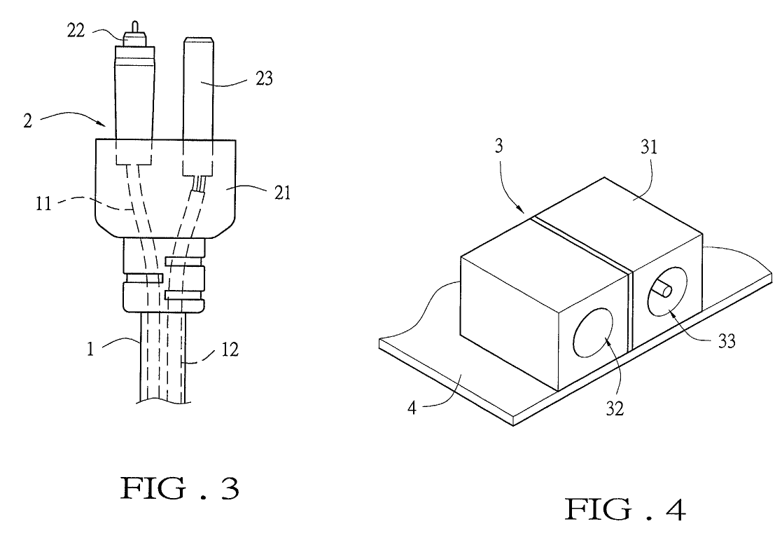

The electro-optical plug 2 is a shell body 21 with a fiber optics plug 22 and line power plug 23. The fiber optics plug 22 connects to the plastic fiber optics 11, the line power plug 23 connects to the copper wire 12, as shown in FIG. 3.

The electro-optical socket 3 is a base 31 with a fiber optics socket 32 and a line power socket 33, the electro-optical socket 3 is installed on an electro-optical peripheral circuit board 4, as shown in FIG. 4.

Based on above structure, the signal transmission plastic fiber optics 11 and the power transmission copper wire 12 are wrapped together into a electro-optical cable 1, both ends of the electro-optical cable 1 has a electro-optical plug 2; the fiber optics plug 22 and line power plug 23 connect to the plastic fiber optics 11 and the copper wire 12 of the electro-optical cable 1 respectively. The fiber optics socket 32 and the line power socket 33 of the electro-optical socket 3 connect to optical receiving and line power circuitries of the electro-optical peripheral circuit board 4; when the electro-optical plug 2 of the electro-optical cable 1 plugs into the electro-optical socket 3, not only the signal is connected, the line power also passes through.

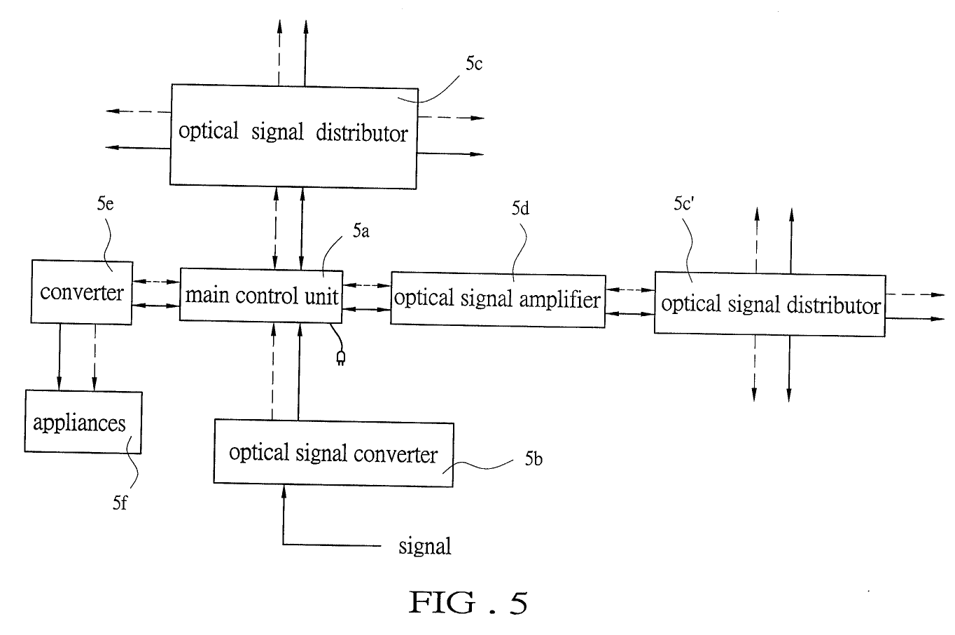

In real application, as shown in FIG. 5, a main control unit 5a connects to an analog to optical signal converter 5b; the main control unit 5a can further connect to an optical signal distributor 5c, then the optical signal distributor 5c connects to other electro-optical appliances. The main control unit 5a can also connect to an optical signal amplifier 5d, the optical signal amplifier 5d connects to another optical signal distributor 5c′; the optical signals are amplified first and transmit to another optical signal distributor 5c′; or the main control unit 5a connects to an optical to analog or digital signal converter 5e, the converter 5e then connects to other appliances 5f. Since the electro-optical cable 1 can transmit optical signals and line power simultaneously to reduce the line power plugs of the peripheral electro-optical appliances, such scheme offers more convenience.

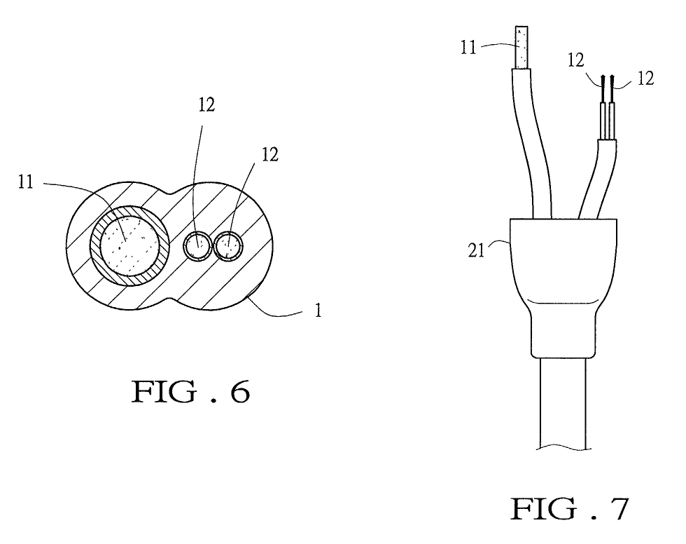

Referring to FIG. 2, the cross section of the electro-optical cable 1 is wrapped in round shape, or in “8” shape, as shown in FIG. 6, this is another application example.

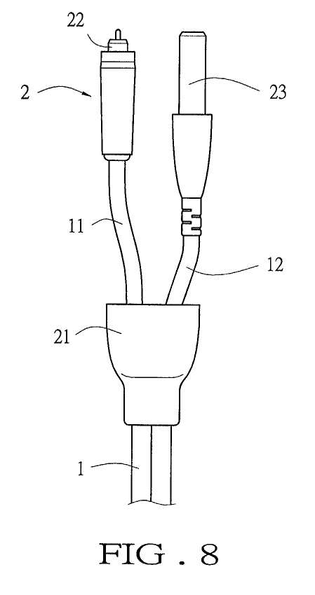

Referring to FIG. 7 and FIG. 8, the plastic fiber optics 11 and the copper wire 12 are on both ends of the electro-optical cable 1; the fiber optics plug 22 connects to the plastic fiber optics 11, the line power plug 23 connects to the copper wire 12, users can choose whether to apply the fiber optics plug 22 and/or the line power plug 23 with different application needs.

A different application example, the fiber optics socket 32 and the line power socket 33 can be formed into one body or separately installed onto the circuit board 4.

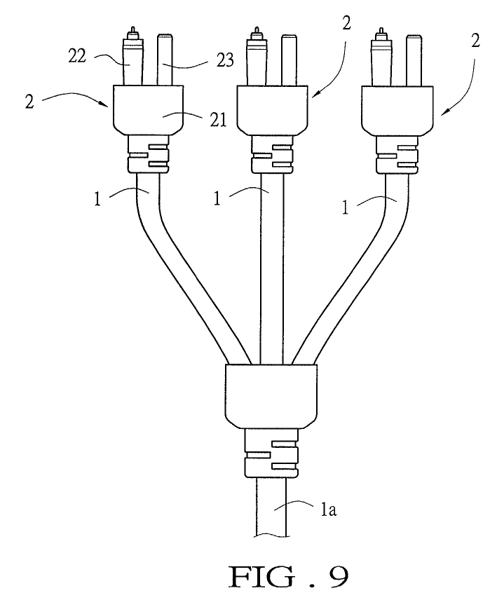

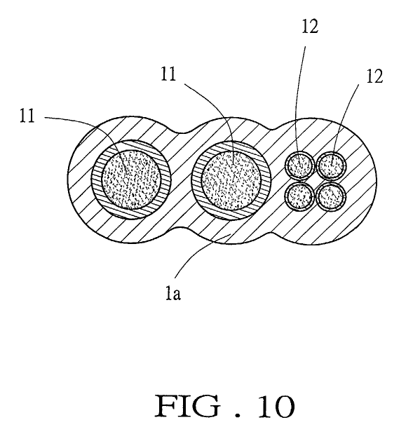

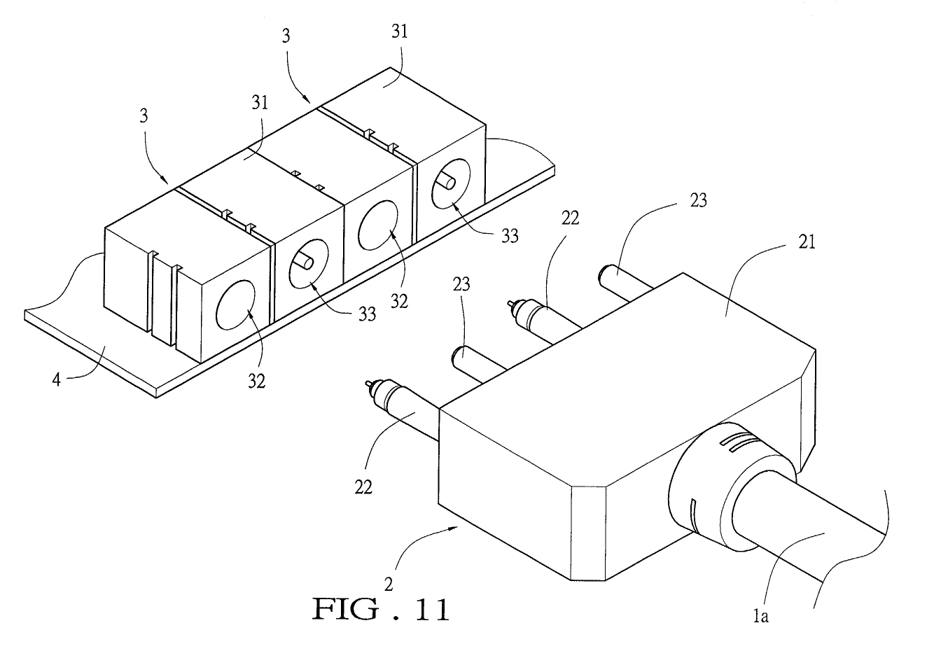

Referring to FIG. 9 and FIG. 10, the electro-optical cable 1 contains multiple plastic fiber optics 11 and the copper wire 12 in parallel to form a new multiple electro-optical cable 1a; every plastic fiber optics 11 and copper wire 12 connects to a fiber optics plug 22 and a line power plug 23, therefore the multiple electro-optical cable 1a has multiple numbers of fiber optics plug 22 and line power plug 23.

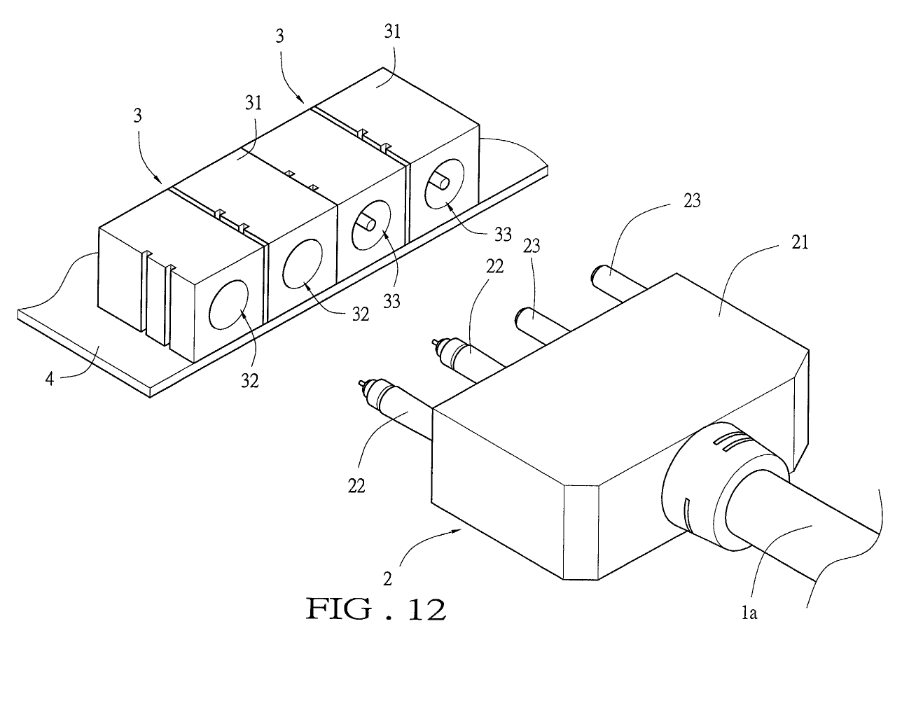

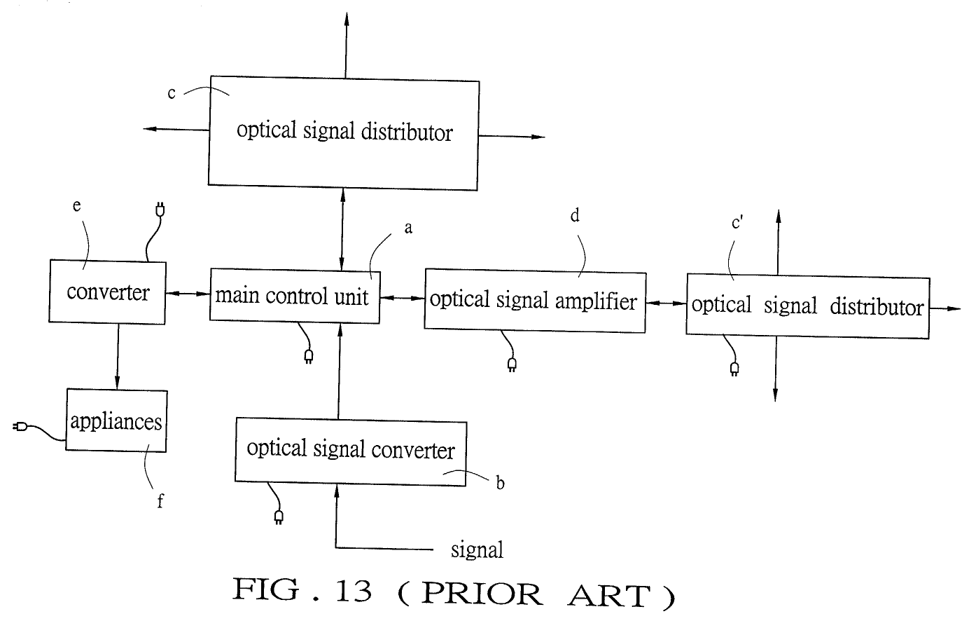

Referring to FIG. 11 and FIG. 12, the fiber optics plug 22 and line power plug 23 on the ends of the multiple electro-optical cable 1a can be formed into a single body; the electro-optical socket 3 of the circuit board 4 has the same numbers of fiber optics socket 32 and line power socket 33.

While a preferred embodiment of the invention has been shown and described in detail, it will be readily understood and appreciated that numerous omissions, changes and additions may be made without departing from the spirit and scope of the invention.

What is claimed is:

1. An electro-optical cable, plug and socket comprising:
an electro-optical cable wrapping a plastic fiber optics and two copper wires together in parallel;
an electro-optical plug in a shell body with a fiber optics plug and line power plug, said fiber optics plug connecting to said plastic fiber optics, said line power plug connecting to said copper wires;
an electro-optical socket installed on a base with said fiber optics socket and said line power socket, said electro-optical socket installed on an electro-optical circuit board.

2. The electro-optical cable, plug and socket recited in claim 1, wherein said fiber optics plug and said line power plug connect to said plastic fiber optics and said copper wire on both ends of said electro-optical cable respectively.

3. The electro-optical cable, plug and socket recited in claim 1, wherein said electro-optical cable containing multiple said plastic fiber optics and said copper wire in parallel to form a multiple electro-optical cable, everyone of said plastic fiber optics and said copper wire connects to one said fiber optics plug and one said line power plug to make said multiple electro-optical cable have multiple numbers of said fiber optics plugs and said line power plugs.

4. The electro-optical cable, plug and socket recited in claim 3, wherein at both ends of said multiple electro-optical cable being formed into a single body, said electro-optical socket of said circuit board has the same numbers of said fiber optics socket and said line power socket.
